(19) United States
(12) Patent Application Publication
(10) Pub. No.: US 2009/0300500 A1
(43) Pub. Date: Dec. 3, 2009

(54) METHODS, APPARATUSES, AND COMPUTER PROGRAM PRODUCTS FOR DETERMINING ICONS FOR AUDIO/VISUAL MEDIA CONTENT

(75) Inventor: Juha Henrik ARRASVUORI, Tampere (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: NOKIA CORPORATION

(21) Appl. No.: 12/132,184

(22) Filed: Jun. 3, 2008

(51) Int. Cl. G06F 3/048

(52) U.S. Cl. 715/723

(57) ABSTRACT

An apparatus may include a processor configured to determine one or more attributes of a video clip. The video clip may comprise a plurality of video frames. The processor may be further configured to determine a video frame from the video clip based upon the one or more determined attributes of the video clip. The processor may be additionally configured to annotate a region of image data with an icon. The icon may comprise the determined video frame and an associated link to the video clip.

### TECHNOLOGICAL FIELD

Embodiments of the present invention relate generally to mobile communication technology and, more particularly, relate to methods, apparatuses, and computer program products for determining icons for audio/visual media content.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users. One area in which there is a demand to further improve the convenience to users is the determination of icons for audio/visual media content that may be annotated to or otherwise embedded in other visual media content. In this regard, annotating regions within digital photos with additional information and links to other media content has become common practice. A photograph may be annotated by attaching tags or links to content or other media files to a region of the photograph. The tagged or linked content may be related to the photograph. These annotations may then be associated with the photograph through the use of metadata or other similar means and the annotated content may be available to a device user who accesses the photograph without requiring the user to further search for the related annotated content. As such, users who have searched for and accessed a photograph may quickly be provided with access to related content simply by clicking on defined regions of the original photograph.

These annotations may comprise icons that may include a thumbnail image and link to video or audio clips. Heretofore, the determination of the thumbnail image has often been arbitrary or has required selection by a user. Accordingly, it may be advantageous to provide computing device users with methods, apparatuses, and computer program products for determining icons for audio/visual media content.

### BRIEF SUMMARY

A method, apparatus, and computer program product are therefore provided to provide for determining icons for audio/visual media content. In particular, a method, apparatus, and computer program product are provided to enable, for example, the determination of a thumbnail image from a video clip with which an image is annotated. The determination of the image may be based upon criteria, which may consider attributes of the annotated image, e.g., the video clip, and/or predefined user preferences or interests. Further, in some embodiments, properties of a link to the video clip and/or other interaction parameters with the annotated region may be determined based upon the one or more of the aforementioned attributes. Additionally, in some embodiments wherein a region of a picture is annotated with an audio clip, properties of a link to the audio clip or other interaction parameters such as a segment of the audio clip played when a user interacts with the annotation may be determined based upon one or more of the aforementioned attributes.

In one exemplary embodiment, a method is provided which may include determining one or more attributes of a video clip. The video clip may comprise a plurality of video frames. The method may further include determining a video frame from the video clip based upon the one or more determined attributes of the video clip. The method may additionally include annotating a region of image data with an icon. The icon may comprise the determined video frame and a link to the video clip.

In another exemplary embodiment, a computer program product is provided. The computer program product includes at least one computer-readable storage medium having computer-readable program code portions stored therein. The computer-readable program code portions include first, second, and third program code portions. The first program code portion is for determining one or more attributes of a video clip, wherein the video clip comprises a plurality of video frames. The second program code portion is for determining a video frame from the video clip based upon the one or more determined attributes of the video clip. The third program code portion is for annotating a region of image data with an icon, wherein the icon comprises the determined video frame and a link to the video clip.

In another exemplary embodiment, an apparatus is provided, which may include a processor. The processor may be configured to determine one or more attributes of a video clip. The video clip may comprise a plurality of video frames. The processor may be further configured to determine a video frame from the video clip based upon the one or more determined attributes of the video clip. The processor may be additionally configured to annotate a region of image data with an icon. The icon may comprise the determined video frame and a link to the video clip.

In another exemplary embodiment, an apparatus is provided that may include means for determining one or more attributes of a video clip, wherein the video clip comprises a plurality of video frames. The apparatus may further include means for determining a video frame from the video clip based upon the one or more determined attributes of the video clip. The apparatus may additionally include means for annotating a region of image data with an icon, wherein the icon comprises the determined video frame and a link to the video clip.

In another exemplary embodiment, a method is provided that may include determining one or more attributes of an audio clip. The audio clip may comprise a plurality of audio segments. The method may further include determining an audio segment from the audio clip based upon the one or more determined attributes of the audio clip. The method may additionally include generating a link to the determined audio segment. The method may also include annotating a region of image data with an icon, wherein the icon comprises the generated link.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 illustrates a block diagram of a system for determining icons for audio/visual media content according to an exemplary embodiment of the invention;

FIG. 2 is a flowchart according to an exemplary method for determining icons for video clip content according to an exemplary embodiment of the invention; and

FIG. 3 is a flowchart according to an exemplary method for determining icons for audio clip content according to an exemplary embodiment of the invention.

### DETAILED DESCRIPTION

Embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

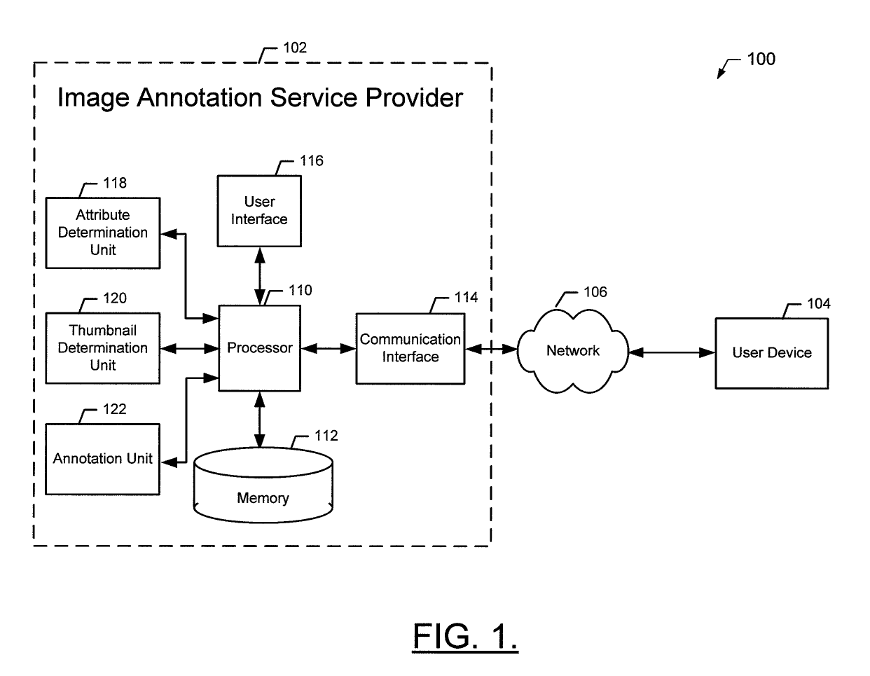

FIG. 1 illustrates a block diagram of a system 100 for determining icons for audio/visual media content according to an exemplary embodiment of the present invention. As used herein, “exemplary” merely means an example and as such represents one example embodiment for the invention and should not be construed to narrow the scope or spirit of the invention in any way. It will be appreciated that the scope of the invention encompasses many potential embodiments in addition to those illustrated and described herein. Further, as used herein, “icons” is not limited in scope by any size or scale of a graphic image comprising the icon. Therefore, use of “thumbnail icon” herein is provided merely for purposes of example in accordance with one embodiment of the invention. Other embodiments of the invention may determine icons of any scale and accordingly the invention is not limited to the determination of thumbnail icons. It should also be noted, that while FIG. 1 illustrates one example of a configuration of a system for determining icons for audio/visual media content, numerous other configurations may also be used to implement embodiments of the present invention.

Referring now to FIG. 1, the system 100 may include an image annotation service provider (“service provider”) 102 and a plurality of user devices 104 configured to communicate with each other over a network 106. The network 106 may comprise any wireline or wireless network or combination thereof and may implement any communications protocol, including, for example various cellular communications protocols and/or internet protocol. In one embodiment, the network 106 may be embodied as the internet. The user device 104 may be any computing device configured to communicate over the network 106 and allow a user to access and interact with the service provider 102. In this regard, the user device 104 may be, for example, a laptop computer, mobile computer, or mobile computing device including, for example, a mobile telephone, personal digital assistant (PDA), portable digital media player, etc. The service provider 102 may be embodied as any computing device or combination of a plurality of computing devices configured to provide for image annotation according to one or more embodiments of the present invention. In this regard, the service provider 102 may be embodied, for example, as a server or a server cluster. Accordingly, the elements of the service provider 102 may be embodied on a single computing device or may be distributed amongst a plurality of computing devices in communication with each other over the network 106 and which collectively provide an image annotation service in accordance with one or more embodiments of the invention described herein. In some embodiments, the service provider 102 may be embodied as a user device 104.

As used herein, “video clip” may include any video data. The video data comprising a video clip may or may not include associated audio data. Further, a video clip as used herein may refer to a video file, such as, for example, an mpeg, mpg, or avi video file. Additionally, a video clip as used herein may refer to raw streaming video data not embodied as a file. “Image data,” as used herein, may comprise raw image data, a single image file, such as a photograph, or may comprise one or more video frames of a video clip. In this regard, one or more frames of a video clip may be annotated in accordance with embodiments of the present invention.

Referring now to the service provider 102, the service provider 102 may include various means, such as a processor 110, memory 112, communication interface 114, user interface 116, attribute determination unit 118, thumbnail determination unit 120, and annotation unit 122 for performing the various functions herein described. The processor 110 may be embodied in a number of different ways. For example, the processor 110 may be embodied as a microprocessor, a coprocessor, a controller, or various other processing elements including integrated circuits such as, for example, an ASIC (application specific integrated circuit) or FPGA (field programmable gate array). In an exemplary embodiment, the processor 110 may be configured to execute instructions stored in the memory 112 or otherwise accessible to the processor 110. Although illustrated in FIG. 1 as a single processor, the processor 110 may comprise a plurality of processors operating in parallel, such as a multi-processor system. In embodiments wherein the processor 110 is embodied as multiple processors, the processors may be embodied in a single computing device or distributed among multiple computing devices, such as a server cluster or amongst computing devices in operative communication with each other over a network, such as the network 106.

The memory 112 may include, for example, volatile and/or non-volatile memory. The memory 112 may be configured to store information, data, applications, instructions, or the like for enabling the service provider 102 to carry out various functions in accordance with exemplary embodiments of the present invention. For example, the memory 112 may be configured to buffer input data for processing by the processor 110. Additionally or alternatively, the memory 112 may be configured to store instructions for execution by the processor 110. As yet another alternative, the memory 112 may comprise one of a plurality of databases that store information in the form of static and/or dynamic information. In this regard, the memory 112 may store, for example, a plurality of user profile data for users of an image annotation and/or other service provided by the service provider 102, such as users of user devices 104. In some embodiments, the user profile data may comprise biographical or other information about a user, which may define the user's hobbies, interests, occupation, and/or demographic information. Additionally or alternatively, the user profile data may comprise user preferences defining criteria for determining thumbnail images. The memory 112 may further store a plurality of image data, which a user of a user device 104 may access and annotate in accordance with embodiments of the present invention. Additionally, the memory 112 may store video clips and/or audio clips, with which image data may be annotated. The memory 112 may additionally store an audio/visual attribute database. The audio/visual search database may comprise a plurality of images and audio data corresponding to recognized objects and attributes. In this regard, the images and audio data stored in the audio/visual attribute database may be compared, such as by the attribute determination unit 118, to image data, video clips, and audio clips to determine attributes of the image data, video clips, and audio clips. This stored information may be stored and/or used by the attribute determination unit 118, thumbnail determination unit 120, and/or the annotation unit 122 during the course of performing their functionalities.

The communication interface 114 may be embodied as any device or means embodied in hardware, software, firmware, or a combination thereof that is configured to receive and/or transmit data from/to a network and/or any other device or module in communication with the service provider 102. The communication interface 114 may be at least partially embodied as or otherwise controlled by the processor 110. In this regard, the communication interface 114 may include, for example, an antenna, a transmitter, a receiver, a transceiver and/or supporting hardware or software for enabling communications with other entities of the system 100, such as a user device 104 via the network 106. In this regard, the communication interface 114 may be in communication with the memory 112, user interface 116, attribute determination unit 118, thumbnail determination unit 120, and/or annotation unit 122. The communication interface 114 may be configured to communicate using any protocol by which the service provider 102 and user device 104 may communicate over the network 106. Accordingly, the communication interface 114 may provide means for communicating with remote devices of the network 106, such as a user device 104. The communication interface 114 may therefore facilitate communicating image data, video clips, and/or audio clips to and from user devices 104. Further, the communication interface 114 may provide means for receiving user commands, such as user instructions for annotating image data, from a user device 104.

The user interface 116 may be in communication with the processor 110 to receive an indication of a user input and/or to provide an audible, visuals mechanical, or other output to the user. Accordingly, the user interface 116 may comprise hardware interface elements, such as, for example, a display, speakers, mouse, joystick, keypad, keyboard, and/or microphone. The user interface 116 may further comprise input/output drivers and other associated software, firmware, and/or hardware necessary to control hardware interface elements and/or otherwise facilitate user interface with the service provider 102. These user interface elements may be executed by or otherwise controlled by the processor 110. The user interface 116 may further be in communication with the attribute determination unit 118, thumbnail determination unit 120, and/or annotation unit 122. Accordingly, the user interface 116 may facilitate access of and interaction with an annotation service or other service, such as may be provided by the service provider 102, by a user of a user device 104. In this regard, the user interface 116 may comprise software elements, hardware elements, firmware elements, or some combination thereof so as to facilitate the provision of a user of a user device 104 with an interface, such as, for example, a web interface, for accessing and annotating image data.

The attribute determination unit 118 may be embodied as various means, such as hardware, software, firmware, or some combination thereof and, in one embodiment, may be embodied as or otherwise controlled by the processor 110. In embodiments where the attribute determination unit 118 is embodied separately from the processor 110, the attribute determination unit 118 may be in communication with the processor 110. The attribute determination unit 118 may be configured to determine attributes of video clips, audio clips, image data, user profile data, and/or user avatars. As used herein, “attributes” may comprise any characteristic of image data, video clips, audio clips, user profiles, and/or user avatars. For example, attributes of image data and video clips may include color, time of day, season, weather conditions, perspective, direction, objects in the image or video, people in the image or video, or animals in the image or video. Each video clip may be comprised of a plurality of still images or “video frames.” In this regard, the attribute determination unit 118 may be configured to determine attributes for a video clip in its entirety, for each individual video frame comprising the video clip and/or for one or more sequences of video frames comprising the video clip. These attributes may, for example, comprise data pre-associated with video clips or image data, such as metadata, and the attribute determination unit 118 may be configured to determine attributes from the associated data. The attribute determination unit 118 may be configured to store the determined attributes in memory 112 in association with the image data or video clip and/or communicate the determined attributes to the thumbnail determination unit 120.

Additionally or alternatively, the attribute determination unit 118 may be configured to determine attributes of image data and video clips through the use of computer vision analysis. In this regard, the attribute determination unit 118 may, in one exemplary embodiment, utilize an algorithm, device or other means for attribute recognition. In such an exemplary embodiment, the attribute recognition algorithm may be configured to determine attributes of image data and video clips by comparing image data and video clips to a series of known objects and attributes, which may be stored in the audio/visual attribute database in memory 112. After determining attributes of image data or video clips through computer vision analysis, the attribute determination unit 118 may be further configured to associate data defining the attributes, such as, for example metadata, with the image data or video clips. The attribute determination unit 118 may be configured to store the determined attributes in memory 112 in association with the image data or video clip and/or communicate the determined attributes to the thumbnail determination unit 120.

The attribute determination unit 118 may additionally be configured to determine attributes of user profile data, such as user profile data for users of user devices 104. This user profile data may be stored in memory 112. In this regard, for example, attributes of user profile data may comprise user hobbies, interests, preferences, location, age, occupation, sex, and/or other demographic information. A user may provide this user profile data when registering for an image annotation service or other service provided by the service provider 102. Accordingly, in an exemplary embodiment, the attribute determination unit 118 may employ a word recognition algorithm that may be configured to search user profile data for words or phrases corresponding to defined attributes. In this regard, the attribute determination unit 118 may be configured to compare excerpts from a user's profile data to an attribute dictionary, which may be stored in memory 112, containing words and phrases corresponding to predefined attributes. The attribute determination unit 118 may be configured to store the determined attributes in memory 112 in association with the user profile data and/or communicate the determined attributes to the thumbnail determination unit 120.

In some embodiments, the attribute determination unit 118 may further be configured to determine attributes of audio clips. In this regard, attributes of audio clips may comprise, for example, sound producing objects in an audio clip; the brightness of the audio clip (e.g. “clear” with predominantly high-frequency components or “murky” with less predominant high frequency components); and/or the intensity, such as volume or duration, of sounds in an audio clip. Sound producing objects in an audio clip may be, a specific sound producing object, such as a dog, specific person, thunder, rain, wind, guitar or other specific musical instrument. Additionally or alternatively, sound producing objects in an audio clip may be a general type or category of sound producing object, such as animal, car, human, weather event, natural phenomenon, music, etc. Each audio clip may be comprised of a plurality of audio segments defined by a discrete starting time and a discrete ending time. In this regard, the attribute determination unit 118 may be configured to determine attributes for each audio segment of an audio clip. The attribute determination unit 118 may be configured to determine attributes of audio clips by comparing sounds comprising an audio clip to a series of known sounds corresponding to sound producing objects or other sounds having predefined attributes, which may be stored in the audio/visual attribute database in memory 112. The attribute determination unit 118 may be configured to store the determined attributes in memory 112 in association with the audio clip and/or communicate the determined attributes to the thumbnail determination unit 120.

In some embodiments, the attribute determination unit 118 may additionally be configured to determine attributes of a user avatar. In this regard, a user avatar may be a virtual representation or visual proxy of a user which a user of a user device 104 may use to browse or otherwise interact with a virtual world, such as may be depicted in image data. Accordingly, the attribute determination unit 118 may be configured to determine attributes of a user avatar using the same techniques as described above with respect to determining attributes of image data and video clips. The attribute determination unit 118 may be configured to store the determined attributes in memory 112 in association with the user avatar and/or communicate the determined attributes to the thumbnail determination unit 120.

The thumbnail determination unit 120 may be embodied as various means, such as hardware, software, firmware, or some combination thereof and, in one embodiment, may be embodied as or otherwise controlled by the processor 110. In embodiments where the thumbnail determination unit 120 is embodied separately from the processor 110, the thumbnail determination unit 120 may be in communication with the processor 110. The thumbnail determination unit 120 may be configured to determine a video frame from a video clip with which image data is to be annotated. The thumbnail determination unit 120 may further be configured to generate an icon comprising the determined video frame. Additionally, the thumbnail determination unit 120 may generate a link to media (video or audio) with which the image data is annotated and associate the link with the generated icon. The thumbnail determination unit 120 may be configured to determine the video frame based upon attributes determined by the attribute determination unit 118. In this regard, the thumbnail determination unit 120 may be configured to receive determined attributes 118 directly from the attribute determination unit 118 and/or retrieve determined attributes stored in memory 112. The thumbnail determination unit 120 may be configured to perform the determination of the video frame based upon the determined attributes in accordance with one or more of the determination methods described below.

In some embodiments, the thumbnail determination unit 120 may be configured to determine a video frame so that the video frame blends, preferably optimally, in with the underlying image data annotated with the video clip. In this regard, the thumbnail determination unit 120 may be configured to compare one or more determined attributes of the image data with one or more determined attributes of the video clip to determine a video frame within the video clip having attributes that most similarly match attributes of the image data. In this regard, the thumbnail determination unit 120 may compare attributes of the entirety of the image data to attributes of video frames of the video clip or may compare only attributes of the immediate region of the image data to be annotated with the video clip. The thumbnail determination unit 120 may be configured to compare attributes using contextual criteria of the image data and video clip, such as, for example, matching a time of day, season, and/or weather conditions depicted in the image data and video clip. For example, if the image data illustrates a photo taken in summer at dawn and having morning mist, the thumbnail determination unit 120 may determine a similar video frame in the video clip. The thumbnail determination unit 120 may additionally or alternatively be configured to compare attributes using visual criteria of the image data and video clip. Visual criteria may include, for example, matching a color or color scheme of the image data, perspective of the image data, and/or direction or orientation of objects illustrated in the image data. For example, if the image data illustrates a red brick wall oriented at a 10 degree angle, the thumbnail determination unit 120 may determine a video frame within the video clip having similar color and object orientation characteristics. The thumbnail determination unit 120 may additionally or alternatively be configured to compare attributes using thematic criteria of the image data and video clip. Thematic criteria may include, for example, matching a theme of the image data, such as may be determined based upon people, vehicles, objects, animals, and/or activities illustrated in the image data. For example, if the image data illustrates a group of people playing football, the thumbnail determination unit 120 may determine a video frame within the video clip having a group of people engaging in a similar activity. In some embodiments, the thumbnail determination unit 120 may be configured to determine a video frame using these criteria based upon user preferences, which may be indicated in user profile data stored in memory 112 or which may be provided by a user of a user device 104 when the user selects a region of image data for annotation with a particular video clip.

In some embodiments, the thumbnail determination unit 120 may be configured to determine a video frame so that the video frame contrasts, preferably optimally, with the underlying image data annotated with the video clip. In this regard, the thumbnail determination unit 120 may be configured to compare one or more determined attributes of the image data with one or more determined attributes of the video clip to determine a video frame within the video clip having attributes that most directly contrast attributes of the image data. In this regard, the thumbnail determination unit 120 may compare attributes of the entirety of the image data to attributes of video frames of the video clip or may compare only those attributes of the immediate region of the image data to be annotated with the video clip. The thumbnail determination unit 120 may be configured to compare attributes using contextual criteria of the image data and video clip. For example, if the image data illustrates a photo taken on a sunny day, the thumbnail determination unit 120 may determine a video frame illustrating a scene at night. The thumbnail determination unit 120 may additionally or alternatively be configured to compare attributes using visual criteria of the image data and video clip. For example, if the image data illustrates a dark color scheme with an object oriented at a 90 degree angle, the thumbnail determination unit 120 may determine a video frame within the video clip having a light color scheme with an object oriented at a 180 degree angle. The thumbnail determination unit 120 may additionally or alternatively be configured to compare attributes using thematic criteria of the image data and video clip. For example, if the image data illustrates a mass of people walking down a busy city street, the thumbnail determination unit 120 may determine a video frame within the video clip illustrating a rural landscape without any people. In some embodiments, the thumbnail determination unit 120 may be configured to determine a video frame using these criteria based upon user preferences, which may be indicated in user profile data stored in memory 112 or which may be provided by a user of a user device 104 when the user selects a region of image data for annotation with a particular video clip.

In some embodiments, the thumbnail determination unit 120 may be configured to determine a video frame based upon attributes of user profile data, such as a user's interest profile corresponding to the user of a user device 104 annotating image data with the video clip. For example, if the user's profile data indicates that the user has an interest in cars, the thumbnail determination unit 120 may be configured to determine a video frame in the video clip illustrating a car. In embodiments where the thumbnail determination unit 120 is configured to determine a video frame based upon attributes of user profile data, the thumbnail determination unit may further be configured to generate a link to the video clip wherein the link refers to the determined video frame such that when a user interacts with the generated link on the annotated image, playback of the video clip will begin at the determined frame having attributes corresponding to attributes of the user's profile data. Embodiments of the invention are not limited to the generated link referring to a playback position beginning with the determined frame, however. Accordingly, in other embodiments, playback may start from the beginning of the video clip or from some other frame of the video clip. Further, criteria for the determination of the point of playback may be configurable, such as by a user.

The thumbnail determination unit 120 may be configured to prioritize video frame determination criteria based upon user preferences. These user preferences may be indicated in user profile data stored in memory 112 or may be provided by a user of a user device 104 when the user selects a region of image data for annotation with a particular video clip. For example a user may indicate a primary determination criteria of “Optimal blend in/Visual/Color” indicating a desire for the thumbnail determination unit 120 to determine a video frame having similar color scheme visual criteria attributes such that the video frame optimally blends in with the image data. The user may indicate secondary determination criteria, such as “Optimal contrast/Contextual/Time of day.” In this regard, the thumbnail determination unit 120 may default to secondary or tertiary user-provided criteria if there is no video frame satisfying the primary criteria. Further, the thumbnail determination unit 120 may be configured to determine video frames based upon complex determination chains combining multiple selection criterions using Boolean logic. These complex determination chains may be indicated by a user preference or may be default determination criteria used by the thumbnail determination unit 120.

In some embodiments, the image annotation service provider 102 may provide a geo-tagged image mapping service, which may, for example, provide a map annotated with media content relating to specific real-world locations represented in the map. In such embodiments, a user may add a video clip to the service having an attribute associated with a particular real-world location. The region of the map image data corresponding to the real-world location may be annotated with the video clip, such as by the annotation unit 122. Accordingly, the thumbnail determination unit 120 may be configured to determine a video frame from the video clip in accordance with any or all of the above discussed criteria based upon attributes of the video clip, map image data, and/or user profile data. The thumbnail determination unit 120 may further be configured to determine a video frame from the video clip that best illustrates a known attribute of the location. For example, if the video clip is associated with Paris, France and the region of the annotated map image data corresponds to Paris, the thumbnail determination unit 120 may be configured to determine a video frame from the video clip illustrating a famous site in Paris, such as the Eiffel Tower.

In some embodiments, the thumbnail determination unit 120 may be configured to determine a video frame based upon attributes of a user avatar. In this regard, the thumbnail determination unit 120 may be configured to determine a video frame based on any one or more of the above discussed criteria based upon determined attributes of the user avatar rather than attributes of the annotated image data. For example, if the user avatar is a cartoon character, the thumbnail determination unit 120 may determine a video frame illustrating the same or similar cartoon character or an object having attributes similar to the cartoon character user avatar.

In embodiments where image data may be annotated with audio clips and in which the attribute determination unit 118 is configured to determine attributes of audio clips, the thumbnail determination unit 120 may be configured to determine an audio segment from the audio clip based upon attributes of the audio clip. The thumbnail determination unit 120 may be configured to determine an audio segment based upon any of the above described criteria, such as, for example, optimal blend in, optimal contrast, or user profile data matching. In this regard, the thumbnail determination unit 120 may match, for example, sound producing objects in the audio clip with objects illustrated in the image data. For example, if the image data to be annotated illustrates a dog, the thumbnail determination unit 120 may determine an audio segment of the audio clip having a barking dog. In another example, the thumbnail determination unit 120 may determine an audio segment of the audio clip based on the brightness of the audio segment, such as by determining a “clear” or “bright” audio segment for image data having bright color, such as image data illustrating a sunny day. As a further example, the thumbnail determination unit 120 may determine a segment having natural phenomena or weather events as a sound producing object and/or category for image data depicting corresponding weather events. The thumbnail determination unit 120 may further be configured to generate a link to the determined audio segment such that when a user interacts with the link, the determined audio segment plays. Embodiments of the invention are not so limited, however, and the thumbnail determination unit 120 may generate a link to the audio clip such that when a user interacts with the link, any segment or plurality of audio segments of the audio clip play. The thumbnail determination unit 120 may determine a default image for the audio clip, such as an image symbolizing an audio clip, which may be, for example a speaker symbol. Accordingly, the thumbnail determination unit 120 may further generate an icon, such as a thumbnail icon, comprising the determined default image and an associated link to the determined audio segment.

The annotation unit 122 may be embodied as various means, such as hardware, software, firmware, or some combination thereof and, in one embodiment, may be embodied as or otherwise controlled by the processor 110. In embodiments where the annotation unit 122 is embodied separately from the processor 110, the annotation unit 122 may be in communication with the processor 110. The annotation unit 122 may be configured to annotate the image data at a region indicated by a user with an image determined by and/or an icon generated by the thumbnail determination unit 120. In this regard, the annotation unit 122 may be configured to annotate the image data with an icon comprising, for example the determined video frame or a scaled representation thereof, such as a thumbnail representation, and an associated link to the video clip, by storing data in association with the image data. In this regard, the annotation unit 122 may be configured to annotate image data according to any of various means for annotating image data, such as by using metadata. Similarly, in embodiments wherein image data may be annotated with audio clips, the annotation unit 122 may be configured to annotate the image data with the generated link to the determined audio segment and/or an icon comprising a default image and an associated link to the audio segment determined by the thumbnail generation unit 120.

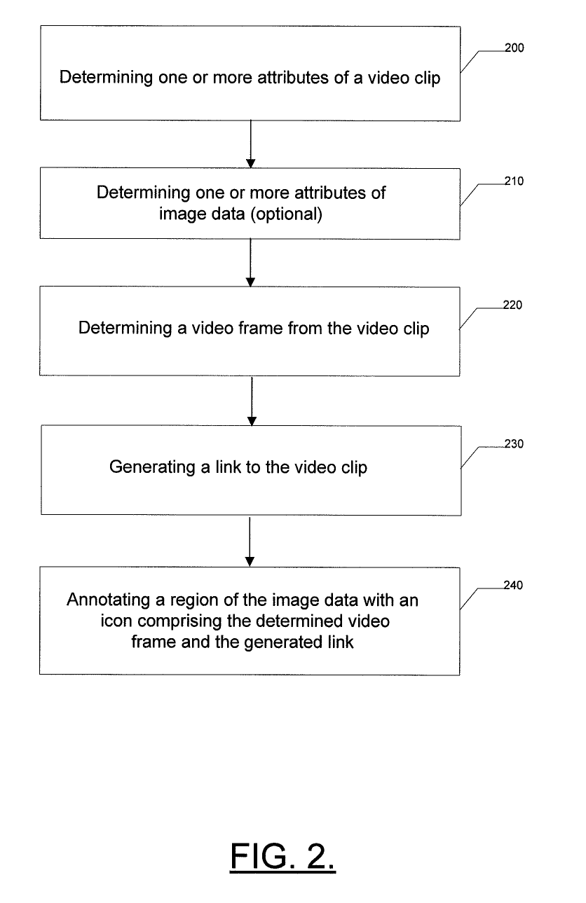

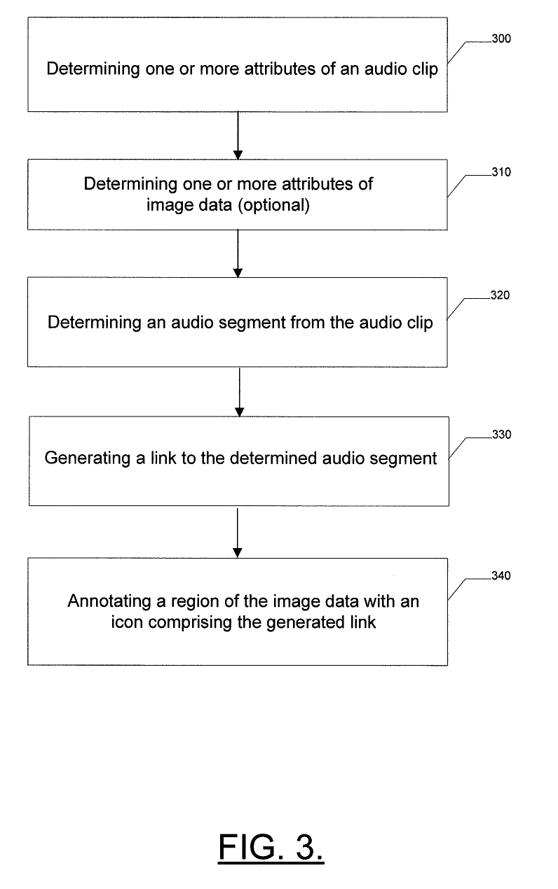

FIGS. 2 and 3 are flowcharts of a system, method, and computer program product according to an exemplary embodiment of the invention. It will be understood that each block or step of the flowcharts, and combinations of blocks in the flowcharts, may be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of a mobile terminal, server, or other computing device and executed by a built-in processor in the computing device. As will be appreciated, any such computer program instructions may be loaded onto a computer or other programmable apparatus (i.e., hardware) to produce a machine, such that the instructions which execute on the computer or other programmable apparatus create means for implementing the functions specified in the flowchart block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowchart block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowchart block(s) or step(s).

Accordingly, blocks or steps of the flowcharts support combinations of means for performing the specified functions, combinations of steps for performing the specified functions and program instruction means for performing the specified functions. It will also be understood that one or more blocks or steps of the flowcharts, and combinations of blocks or steps in the flowcharts, may be implemented by special purpose hardware-based computer systems which perform the specified functions or steps, or combinations of special purpose hardware and computer instructions.

In this regard, one exemplary method for determining icons for video clip content according to an exemplary embodiment of the invention is illustrated in FIG. 2. The method may include the attribute determination unit 118 determining one or more attributes of a video clip at operation 200. The video clip may comprise a plurality of video frames. Operation 210 may optionally comprise the attribute determination unit 118 determining one or more attributes of image data. The method may further include the thumbnail determination unit 120 determining a video frame from the video clip at operation 220. Operation 230 may comprise the thumbnail determination unit 120 generating a link to the video clip. Operation 240 may comprise the annotation unit 122 annotating a region of the image data with an icon comprising the determined video frame and the generated link.

Referring now to FIG. 3, FIG. 3 illustrates an exemplary method for determining thumbnail icons for audio clip content according to an exemplary embodiment of the invention. The method may include the attribute determination unit 118 determining one or more attributes of an audio clip at operation 300. The audio clip may comprise a plurality of audio segments. Operation 310 may optionally comprise the attribute determination unit 118 determining one or more attributes of image data. The method may further include the thumbnail determination unit 120 determining an audio segment from the audio clip at operation 320. Operation 330 may comprise the thumbnail determination unit 120 generating a link to the determined audio segment. The method may also include the annotation unit 122 annotating a region of the image data with an icon comprising the generated link at operation 340.

The above described functions may be carried out in many ways. For example, any suitable means for carrying out each of the functions described above may be employed to carry out embodiments of the invention. In one embodiment, all or a portion of the elements generally operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

As such, then, some embodiments of the invention may provide several advantages to a user of a computing device. Embodiments of the invention may provide for determining icons for audio/visual media content. In particular, a method, apparatus, and computer program product are provided to enable, for example, the determination of an image from a video clip with which an image is annotated. The determination of the image may be based upon criteria, which may consider attributes of the annotated image, the video clip, and/or predefined user preferences or interests. Further, in some embodiments, properties of a link to the video clip and/or other interaction parameters with the annotated region may be determined based upon the one or more of the aforementioned attributes.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
determining one or more attributes of a video clip, wherein the video clip comprises a plurality of video frames;
determining a video frame from the video clip based upon the one or more determined attributes of the video clip; and
annotating a region of image data with an icon, wherein the icon comprises the determined video frame and an associated link to the video clip.

2. A method according to claim 1, further comprising:
determining one or more attributes of the image data; and
wherein determining a video frame further comprises determining the video frame by comparing the one or more determined attributes of the image data and the one or more determined attributes of the video clip.

3. A method according to claim 2, wherein determining a video frame further comprises determining the video frame so that the video frame blends with the image data based upon one or more of contextual criterion, visual criterion, or thematic criterion.

4. A method according to claim 2, wherein determining a video frame further comprises determining the video frame so that the video frame contrasts with the image data based upon one or more of contextual criterion, visual criterion, or thematic criterion.

5. A method according to claim 1, wherein determining a video frame further comprises determining the video frame by comparing one or more user-provided attributes to the one or more determined attributes of the video clip.

6. A method according to claim 5, wherein the link to the video clip refers to a position in the video clip beginning with the determined video frame.

7. A method according to claim 1, wherein determining one or more attributes of a video clip comprises determining one or more attributes based upon data associated with the video clip or based upon computer vision analysis of the video clip.

8. A method according to claim 1, further comprising:
determining one or more attributes of a user avatar, wherein the user avatar is used to interact with the image data; and
wherein determining a video frame further comprises determining the video frame by comparing the one or more determined attributes of the avatar and the one or more determined attributes of the video clip.

9. A method according to claim 1, wherein the video clip is associated with a location; and
wherein annotating a region of image data with an icon, comprises annotating a region of the image data associated with the same location.

10. A computer program product comprising at least one computer-readable storage medium having computer-readable program code portions stored therein, the computer-readable program code portions comprising:
a first program code portion for determining one or more attributes of a video clip, wherein the video clip comprises a plurality of video frames;
a second program code portion for determining a video frame from the video clip based upon the one or more determined attributes of the video clip; and
a third program code portion for annotating a region of image data with an icon, wherein the icon comprises the determined video frame and an associated link to the video clip.

11. A computer program product according to claim 10, further comprising:
a fourth program code portion for determining one or more attributes of the image data; and
wherein the second program code portion includes instructions for determining the video frame by comparing the one or more determined attributes of the image data and the one or more determined attributes of the video clip.

12. A computer program product according to claim 11, wherein the second program code portion includes instructions for determining the video frame so that the video frame blends with the image data based upon one or more of contextual criterion, visual criterion, or thematic criterion.

13. A computer program product according to claim 11, wherein the second program code portion includes instructions for determining the video frame so that the video frame contrasts with the image data based upon one or more of contextual criterion, visual criterion, or thematic criterion.

14. A computer program product according to claim 10, wherein the second program code portion includes instructions for determining the video frame by comparing one or more user-provided attributes to the one or more determined attributes of the video clip.

15. A computer program product according to claim 14, wherein the link to the video clip refers to a position in the video clip beginning with the determined video frame.

16. A computer program product according to claim 10, wherein the first program code portion includes instructions for determining one or more attributes based upon data associated with the video clip or based upon computer vision analysis of the video clip.

17. A computer program product according to claim 10, further comprising:
a fourth program code portion for determining one or more attributes of a user avatar, wherein the user avatar is used to interact with the image data; and
wherein the second program code portion includes instructions for determining the video frame by comparing the one or more determined attributes of the avatar and the one or more determined attributes of the video clip.

18. A computer program product according to claim 10, wherein the video clip is associated with a location; and
wherein the third program code portion includes instructions for annotating a region of the image data associated with the same location.

19. An apparatus comprising a processor configured to:
determine one or more attributes of a video clip, wherein the video clip comprises a plurality of video frames;
determine a video frame from the video clip based upon the one or more determined attributes of the video clip; and
annotate a region of image data with an icon, wherein the icon comprises the determined video frame and a link to the video clip.

20. An apparatus according to claim 19, wherein the processor is further configured to:
determine one or more attributes of the image data; and
determine the video frame by comparing the one or more determined attributes of the image data and the one or more determined attributes of the video clip.

21. An apparatus according to claim 20, wherein the processor is further configured to determine the video frame so that the video frame blends with the image data based upon one or more of contextual criterion, visual criterion, or thematic criterion.

22. An apparatus according to claim 20, wherein the processor is further configured to determine the video frame so that the video frame contrasts with the image data based upon one or more of contextual criterion, visual criterion, or thematic criterion.

23. An apparatus according to claim 19 wherein the processor is further configured to determine the video frame by comparing one or more user-provided attributes to the one or more determined attributes of the video clip.

24. An apparatus according to claim 23 wherein the link to the video clip refers to a position in the video clip beginning with the determined video frame.

25. An apparatus according to claim 19, wherein the processor is further configured to determine one or more attributes of the video clip based upon data associated with the video clip or based upon computer vision analysis of the video clip.

26. An apparatus according to claim 19, wherein the processor is further configured to:
determine one or more attributes of a user avatar, wherein the user avatar is used to interact with the image data; and
wherein the processor is configured to determine a video frame by comparing the one or more determined attributes of the avatar and the one or more determined attributes of the video clip.

27. An apparatus according to claim 19, wherein the video clip is associated with a location; and
wherein the processor is further configured to annotate a region of the image data associated with the same location.

28. An apparatus comprising:
means for determining one or more attributes of a video clip, wherein the video clip comprises a plurality of video frames;
means for determining a video frame from the video clip based upon the one or more determined attributes of the video clip; and
means for annotating a region of image data with an icon, wherein the icon comprises the determined video frame and a link to the video clip.

29. A method comprising:
determining one or more attributes of an audio clip, wherein the audio clip comprises a plurality of audio segments;
determining an audio segment from the audio clip based upon the one or more determined attributes of the audio clip;
generating a link to the determined audio segment; and
annotating a region of image data with an icon, wherein the icon comprises the generated link.

30. A method according to claim 29, further comprising:
determining one or more attributes of the image data; and
wherein determining an audio segment further comprises determining the audio segment by comparing the one or more determined attributes of the image data and the one or more determined attributes of the audio clip.

31. A method according to claim 29, wherein determining an audio segment further comprises determining the audio segment by comparing one or more user-provided attributes to the one or more determined attributes of the audio clip.
